(19) United States
(12) Patent Application Publication
(10) Pub. No.: US 2017/0172339 A1
(43) Pub. Date: Jun. 22, 2017

(54) TEA INFUSER

(71) Applicant: UMBRA LLC, Buffalo, NY (US)

(72) Inventor: Eugenie De Loynes, Toronto (CA)

(21) Appl. No.: 14/979,033

(22) Filed: Dec. 22, 2015

(51) Int. Cl. A47J 31/20; A23F 3/18; A47J 31/06

(52) U.S. Cl. CPC A47J 31/20; A47J 31/0626; A47J 31/0636; A23F 3/18

(57) ABSTRACT

A tea infuser, including a bendable arm, wherein the bendable arm includes a bendable inner member surrounded by a flexible material, a detachable basket arranged to contain tea leaves, and a shoulder comprised of the flexible material arranged at an end of the bendable arm, wherein the detachable basket is arranged to be detachably secured to the shoulder.

### FIELD OF THE INVENTION

The invention broadly relates to tea infusers for preparing tea from loose tea leaves.

### BACKGROUND OF THE INVENTION

The beverage tea is commonly prepared by submersing a pre-made tea bag into a cup or pot of hot water. The hot water penetrates the paper or cloth material of the tea bag, surrounding and wetting the dried tea leaves within the tea bag. This process, which is known as “steeping” or “brewing,” creates tea, which then flows back through the paper or cloth material of the tea bag into the cup or pot. After the steeping process is complete, the tea bag is removed, with the tea leaves still contained within the tea bag.

As an alternative to tea bags, tea may be prepared by placing loose, dried tea leaves into hot water. Brewing tea with loose tea leaves may be preferred over tea bags, as it permits tea drinkers to adjust the quantity and blending of the tea leaves used during the tea is brewing process. Although loose tea leaves may be placed directly into hot water without any type of containment, the tea leaves must be removed from the brewed tea before it is consumed.

To avoid this extra step, loose tea leaves may first be placed within a tea infuser, a reusable device for containing loose tea leaves. Like tea bags, tea infusers contain the tea leaves during the brewing process, reducing the amount of the clean-up required before the tea can be consumed. Unlike tea bags, tea infusers are reusable, and they can be reloaded with fresh tea leaves for additional brewing. To this end, tea infusers generally have an accessible inner compartment, which can be loaded with loose tea leaves.

Tea infusers may have a portion or assembly that is not submersed in the hot water during the brewing process. This portion of the tea infuser is used as a handle to place the tea infuser in and remove the tea infuser from the water without forcing the user to come in contact with the potentially dangerously hot water. This portion may also secure the tea infuser to the cup or pot of hot water so that the tea infuser cannot move freely within the container. This stability may be useful, if, for instance, the container is moved during the brewing process.

Further, a tea infuser should ideally be adaptable for use in a variety of cups and pots, as these containers vary widely in shape and size. Thus, what is needed is a tea infuser that can contain loose tea leaves during the brewing process, but that can also be used in a variety of tea-brewing containers while remaining secured to such containers during the tea brewing process.

### BRIEF SUMMARY OF THE INVENTION

The present invention is a tea infuser, including a bendable arm, a detachable basket arranged to contain tea leaves, and a shoulder arranged at an end of the bendable arm, wherein the detachable basket is arranged to be detachably secured to the shoulder.

The present invention is also a tea infuser, including a bendable arm, wherein the bendable arm includes a bendable inner member surrounded by a flexible material, a detachable basket arranged to contain tea leaves, and a shoulder comprised of the flexible material arranged at an end of the bendable arm, wherein the detachable basket is arranged to be detachably secured to the shoulder.

In another embodiment, the bendable arm of the tea infuser includes a bendable inner member arranged within the flexible material.

The primary object of the invention is to provide a tea infuser with a bendable arm that can be secured to a variety of tea-brewing containers.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of an apparatus of e present invention, showing the tea infuser;

FIG. 2 is a front elevational view of an apparatus shown in FIG. 1;

FIG. 3 is a cross-sectional view of the apparatus shown in FIG. 2 taken along line 3-3; and,

FIG. 4 is right side elevational view of the apparatus shown in FIG. 1 shown in use in association with a cup of hot water.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspect. The present invention is intended to include various modifications and equivalent arrangements within the spirit and scope of the appended claims.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

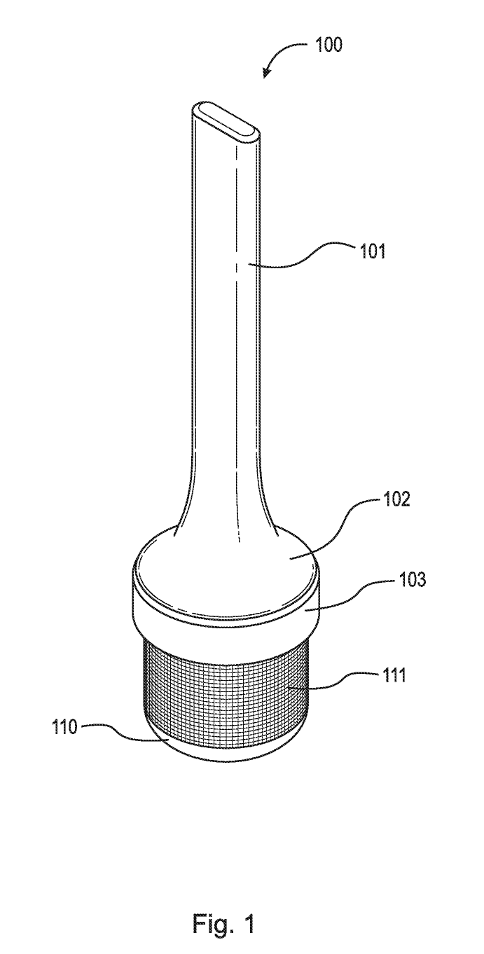

Adverting now to the figures, FIG. 1 is a perspective view of an apparatus of the present invention, showing tea infuser 100. Tea infuser 100 includes bendable arm 101, detachable basket 110 arranged to contain tea leaves, and shoulder 103 arranged at an end of bendable arm 101. Shoulder 103 is arranged such that detachable basket 110 is arranged to be detachably secured to shoulder 103. In an example embodiment, tea infuser 100 includes neck 102 arranged between bendable arm 101 and shoulder 103 that serves as a transitionary element to mate generally narrower bendable arm 101 with generally wider shoulder 103.

Bendable arm 101 is made from a flexible material that can withstand repeated bending without breaking. Additionally, it is desirable for the flexible material used to make bendable arm 101 to be heat resistant, as tea infuser 100 will be at least partially submerged in hot water during operation. Some teas are brewed at or near 100° C., so the flexible material must be able to withstand such temperatures without melting or losing structural integrity. Further, it is advantageous for the flexible material to be a thermal insulator, so that heat from the hot water is not conducted up bendable arm 101, which could make grasping bendable arm 101 uncomfortable or dangerous. Accordingly, in an example embodiment, an elastic material, such as silicone, rubber, or soft plastic, is used to construct bendable arm 101. In an example embodiment, shoulder 103 and neck 102 are also made from the flexible material of bendable arm 101, and bendable arm 101, shoulder 103, and neck 102 consist of a single piece of flexible material.

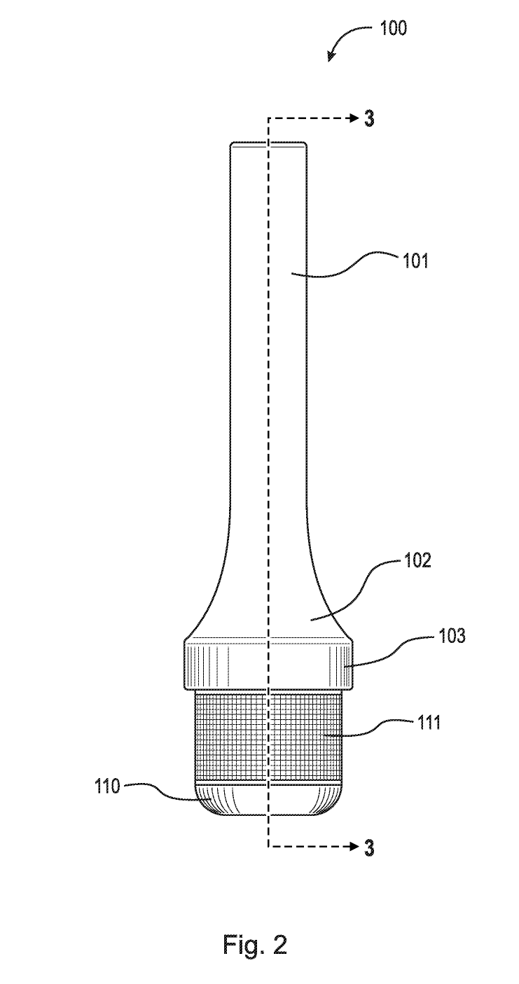

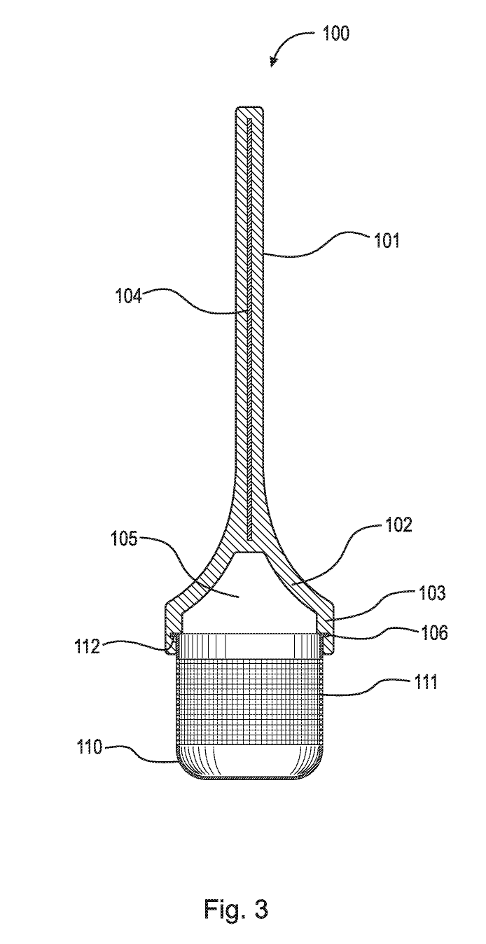

FIG. 2 is a front elevational view of tea infuser 100. Detachable basket 110 can be made from any rigid material that can structurally support a plurality of openings. In example embodiments, detachable basket 110 is made from stainless steel, aluminum, or plastic. A plurality of basket openings 111 are arranged in detachable basket 110. In example embodiments, basket openings 111 may comprise a plurality of holes, other through-bores, or slits in detachable basket 110, or in an example embodiment, detachable basket 110 is made substantially from a mesh material. In FIG. 3, basket openings 111 are shown as a wire mesh. Basket openings 111 must be large enough to support the flow of water both in to and out of detachable basket 110, but small enough to contain the majority of the loose tea leaves within detachable basket 110. In an example embodiment, detachable basket 110 is substantially cylindrical, with an axis of rotation coaxial with the longitudinal axis of bendable arm 101.

FIG. 3 is a cross-sectional view of tea infuser 100 taken along line 3-3. In an example embodiment, bendable arm 101 includes bendable inner member 104, which is arranged within the flexible material that comprises the exterior of bendable arm 101. Bendable inner member 104 is arranged substantially coaxial to the longitudinal axis of bendable arm 101 and extends substantially the entire length of bendable arm 101. In an example embodiment, the profiles of both bendable arm 101 and bendable inner member 104 are substantially rectangular and oriented similarly within each other when viewed from a transverse plane, i.e., the plane orthogonal to the common longitudinal axis of bendable arm 101 and bendable inner member 104. It is thereby easier to bend bendable inner member 104 and bendable arm 101 in some directions than others.

In an example embodiment, bendable inner member 104 is made from a bendable material such that bendable inner member 104 can be bent and retain the received bend as plastic deformation of bendable inner member 104, i.e., without the elastic forces exerted by bendable arm 101 or bendable inner member 104 causing bendable inner member 104 to straighten. This bending of bendable inner member 104 effectively bends and keeps bendable arm 101 bent in a similar bend as bendable inner member 104. Additionally, bendable inner member 104 can be straightened by bending bendable inner member 104 in such a way as to remove any received bends. As bendable inner member 104 extends substantially the entire length of bendable arm 101, bendable arm 101 can receive and keep a bend substantially anywhere along its length. In an example embodiment, bendable inner member 104 is made from copper, aluminum, steel, or similarly flexible metals than can be bent repeatedly without breaking.

In an example embodiment, shoulder 103 includes a groove 106 into which flange 112 on detachable basket 110 can be secured. This permits detachable basket 110 to be attached to and removed from shoulder 103 by elastically deforming the flexible material of shoulder 103 to fit flange 112 of detachable basket 110 into groove 106. Detachable basket 110 may also be attached to shoulder 103 by means of pressure fit with shoulder 103. In an example embodiment, when detachable basket 110 is attached to shoulder 103, the common interior space of detachable basket 110 and shoulder 103 forms interior region 105. Loose tea leaves can be placed within detachable basket 110 before it is attached to shoulder 103. Similarly, loose tea leaves that have already been used to brew tea can be removed from interior region 105 by removing detachable basket 110 from shoulder 103 and manually removing the used loose tea leaves contained within detachable basket 110 and shoulder 103. In an example embodiment, detachable basket 110 and shoulder 103 are substantially cylindrical, with a shared axis of rotation substantially coaxial with the longitudinal axis of bendable arm 101, such that shoulder 103 has a first radius, detachable basket 110 has a second radius, and the first radius is larger than the second radius. This difference in respective radii allows detachable basket 110 to fit within shoulder 103.

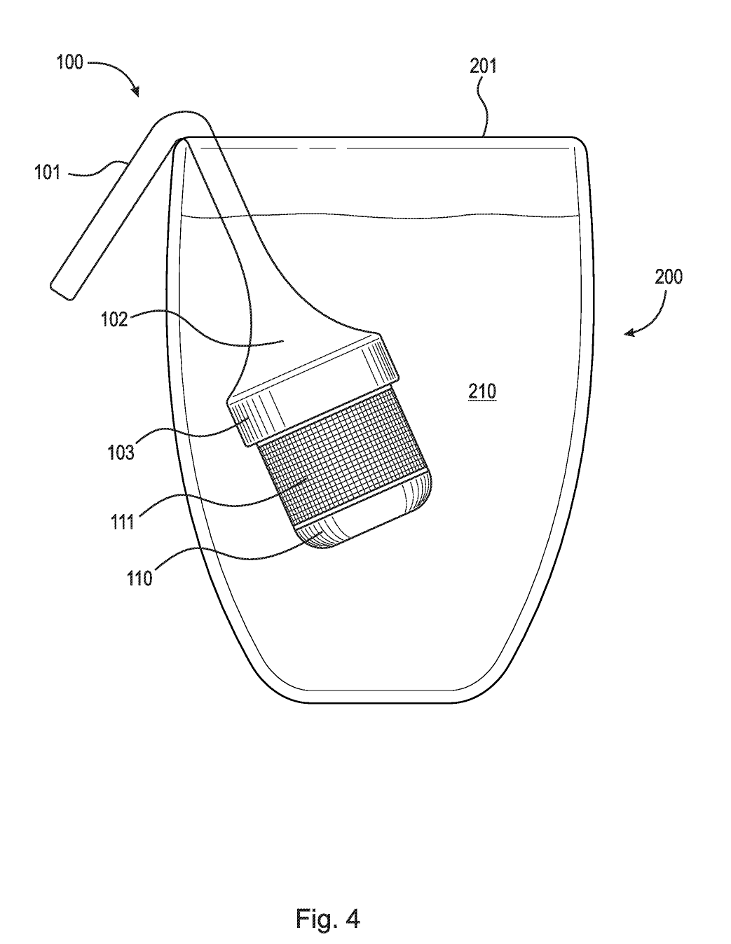

FIG. 4 is right side elevational view of tea infuser 100 shown in use in association with cup 200 of water 210. As shown in FIG. 4, bendable arm 101 of tea infuser 100 has been bent such that the interior vertex of the bend in bendable arm 101 hooks onto cup rim 201, As the portion of tea infuser 100 that has been inserted into water 210 is not buoyant, gravity pulls tea infuser 100 down, suspending and securing tea infuser 100 against cup 200. As the portion of tea infuser 100 that is submerged includes shoulder 103 and detachable basket 110, water 210 can flow through basket openings 111 and come in contact with loose tea leaves within detachable basket 110. This contact produces tea, which can then flow back out basket openings 111 and into cup 200, This process continues until the loose tea leaves are spent or tea infuser 100 is removed from cup 200.

As bendable arm 101 is bendable along substantially its entire length, the location of the bend, and thus, the location of the point of suspension on cup 200 can be varied. Thus, tea infuser 100 can be suspended from cups or other tea brewing vessels of varying sizes and shapes. Further, as bendable arm 101, neck 102, and shoulder 103 are comprised of a flexible material, as opposed to a hard material, contact between these components and cup 200 is less likely to damage cup 200. As tea infuser 100 can be secured to a variety of cups and other tea brewing vessels, these cups and/or vessels can be transported safely with tea infuser 100 secured thereto. Additionally, because bendable arm 101 can be bent and thereby secured to cup 200 by hooking onto cup rim 201, a portion of tea infuser 100 always remains outside of water 210. This permits tea infuser 100 to be inserted in and removed from cup 200 without the user coming in contact with water 210, which may be hot. As it is not fully submerged in water 210, tea infuser 100 may also be manipulated during the tea brewing process, for instance, tea infuser 100 may be swirled within cup 200 and water 210 to stir the brewing tea.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### REFERENCE NUMBERS

100 tea infuser

101 bendable arm

102 neck

103 shoulder

104 bendable inner member

105 interior region

106 groove

110 detachable basket

111 basket openings

112 flange

200 cup

201 cup rim

210 water

What is claimed is:

1. A tea infuser, comprising:
a bendable arm;
a detachable basket arranged to contain tea leaves; and,
a shoulder arranged at an end of the bendable arm, wherein the detachable basket is arranged to be detachably secured to the shoulder.

2. The tea infuser recited in claim 1, wherein the bendable arm comprises a bendable inner member arranged within a flexible material.

3. The tea infuser recited in claim 2, wherein the shoulder is comprised of the flexible material of the bendable arm.

4. The tea infuser recited in claim 2, wherein the flexible material is heat resistant.

5. The tea infuser recited in claim 2, wherein the flexible material is a thermal insulator.

6. The tea infuser recited in claim 2, wherein the flexible material is selected from the group consisting of silicone, rubber, or soft plastic.

7. The tea infuser recited in claim 2, wherein the bendable inner member is comprised of a material selected from the group consisting of copper, aluminum, and steel.

8. The tea infuser recited in claim 1, wherein the detachable basket includes a flange arranged to fit within a groove in the shoulder.

9. The tea infuser recited in claim 1, wherein the bendable arm is bendable along substantially an entire length of the bendable arm.

10. The tea infuser recited in claim 1, wherein the bendable arm has a substantially rectangular profile viewed from a transverse plane.

11. The tea infuser recited in claim 2, wherein the bendable inner member has a substantially rectangular profile viewed from a transverse plane.

12. The tea infuser recited in claim 1, wherein the detachable basket is substantially cylindrical.

13. The tea infuser recited in claim 1, wherein the detachable basket is comprised of a rigid material.

14. The tea infuser recited in claim 1, wherein the detachable basket is comprised of a material selected from the group consisting of stainless steel, aluminum, and plastic.

15. The tea infuser recited in claim 1, wherein the detachable basket is substantially comprised of a mesh material.

16. The tea infuser recited in claim 1, wherein the detachable basket includes a plurality of holes.

17. The tea infuser recited in claim 1, wherein the shoulder and detachable basket surround an interior region.

18. The tea infuser recited in claim 1, wherein the shoulder has a first radius, the detachable basket has a second radius, and the first radius is larger than the second radius.

19. A tea infuser, comprising:
a bendable arm, wherein the bendable arm comprises a bendable inner member surrounded by a flexible material;
a detachable basket arranged to contain tea leaves; and,
a shoulder comprised of the flexible material arranged at an end of the bendable arm, wherein the detachable basket is arranged to be detachably secured to the shoulder.
